(19) United States
(12) Patent Application Publication
(10) Pub. No.: US 2015/0095111 A1
(43) Pub. Date: Apr. 2, 2015

(54) METHOD AND SYSTEM FOR USING SOCIAL MEDIA FOR PREDICTIVE ANALYTICS IN AVAILABLE-TO-PROMISE SYSTEMS

(71) Applicant: Sears Brands L.L.C., Hoffman Estates, IL (US)

(72) Inventor: Jen-Chieh Tang, Arlington Heights, IL (US)

(21) Appl. No.: 14/496,794

(22) Filed: Sep. 25, 2014

Related U.S. Application Data
(60) Provisional application No. 61/883,238, filed on Sep. 27, 2013.

(51) Int. Cl. G06Q 30/02; G06Q 50/00

(52) U.S. Cl. CPC G06Q 30/0202; G06Q 50/01
USPC 705/7.31

(57) ABSTRACT

A method and system are provided in which a computing device comprising an available-to-promise system of a merchant or business collects information content from at least one social networking website. The computing device may analyze the collected information content to extract data items that identify a product or service. Based on a result of the analysis, a composite score of predicted demand for the product or service may be generated by the computing device. The score may be used in the ATP system for generating a demand forecast used by the merchant or business in purchasing or allocating the product or service.

### CROSS-REFERENCE TO RELATED APPLICATIONS/INCORPORATION BY REFERENCE

The present application makes reference to, claims priority to, and claims benefit of U.S. Provisional Patent Application No. 61/883,238 entitled “Method and System for Using Social Media for Predictive Analytics in Available to Promise (ATP) Systems,” filed Sep. 27, 2013, the complete subject matter of which is hereby incorporated herein by reference, in its entirety.

### FIELD

Certain embodiments of the disclosure relate to inventory availability systems. More specifically, certain embodiments of the disclosure relate to a method and system for using social media for predictive analytics in available-to-promise (ATP) systems.

### BACKGROUND

Existing methods and systems for predictive analytics in inventory availability systems such as available-to-promise (ATP) systems may be ineffective.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method is provided for using social media for predictive analytics in available-to-promise (ATP) systems, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an example computer network environment for using social media for predictive analytics in an available-to-promise (ATP) system, in accordance with an embodiment of the disclosure.

FIG. 2 is a flow chart illustrating example steps for using social media for predictive analytics in an available-to-promise (ATP) system, in accordance with an example embodiment of the disclosure.

FIG. 3 is an example data flow diagram illustrating the flow of information to and from the various functional elements of a system for using social media for predictive analytics in an available-to-promise (ATP) system, in accordance with the present disclosure.

FIG. 4 illustrates an example method of operating a system for using social media for predictive analytics in an available-to-promise (ATP) system, in accordance with the present disclosure.

### DETAILED DESCRIPTION

The present disclosure relates to inventory availability systems. More specifically, certain embodiments of the disclosure relate to a method and system for using social media for predictive analytics for use in available-to-promise (ATP) systems. Information content collected from various information sources, including information content from social networks, may be indicative of consumer sentiment, and may be used to predict consumer demand for various product or service items, enabling a merchant or business to more accurately predict demand for the product or service items. Such predictions of product or service demand may be used to guide product manufacturing and purchase activities and allocation of the product or service items to various merchant locations and distribution channels for sale to the consumer.

As utilized herein the terms “circuit” and “circuitry” refer to physical electronic components (i.e. hardware) and any software and/or firmware (“code”) which may configure the hardware, be executed by the hardware, and/or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a device/module/circuitry/etc. is “operable” to perform a function whenever the device/module/circuitry/etc. comprises the necessary hardware and code (if any is necessary) to perform the function, regardless of whether performance of the function is disabled, or not enabled, by some user-configurable setting.

The term “available to promise system” may be used herein to refer to a computer system for providing information regarding on-hand inventory or resource time available for commitment to customer orders.

The terms “merchant” and “sponsoring merchant/merchants” may be used herein to refer to the owner and/or operator of a business enterprise that operates either or both of traditional “brick-and-mortar” business locations or an e-commerce or social e-commerce platform as described herein, or enters into an agreement with another to operate such a platform on their behalf.

The term “loyalty program” may be used herein to refer to a structured marketing effort that rewards, and therefore encourages, loyal buying behavior that is potentially beneficial to the business or firm operating or sponsoring the loyalty program. The term “member” may be used herein to refer to those consumers that have provided personal information to an operator or sponsor of a loyalty program in order to gain access to benefits provided by the loyalty program.

The terms “customer,” “consumer,” “end-user,” and “user” may be used herein interchangeably to refer to a potential or existing purchaser of products and/or services of a merchant or business.

The term “social network” may be used herein to refer to a network of family, friends, colleagues, and other personal contacts, or to an online community of such individuals who use a website or other technologies to communicate with each other, share information, resources, etc. The term “social graph” may be used herein to refer to a representation of the personal relationships or connections between individuals in a population.

The term “channel” may be used herein, depending upon context, to refer to various means of communicating such as, for example, online communication (e.g., Internet-based), mobile communication (e.g., wireless communication such as cellular or Wi-Fi), telephone communication, and in-store communication. The term “channel” may also be used herein, depending upon context, to refer to the conduit or path used by an entity for delivering goods, services, and/or information to a customer, consumer, end-user, or user such as, for example, retail, online, telephone order, or mail-order.

The term “e-commerce” may be used herein to refer to business or commerce that is transacted electronically, as over the Internet.

The term “social e-commerce” may be used herein to refer to e-commerce in which consumers interact with other consumers socially as part of e-commerce activities. Merchants or businesses may take part in social e-commerce by engaging consumers in various activities including, by way of example and not limitation, email messaging, text messaging, games, and posting or monitoring of activities and information exchanged on social networking platforms (e.g., Facebook®) and/or merchant supported social networks.

The terms “like,” “want,” “have” or “own,” and “recommend” may be used to refer to particular social signals that may be represented on a web page in association with a product, and may be selected by a consumer to represent their relationship with or feeling about the product.

The term “follow” may be used herein to refer to a user request to be kept informed about a particular person, place, or thing.

The term “share” may be used herein to refer to a user request to communicate information about what is being viewed by a user to members of the user's family, friends, or social network.

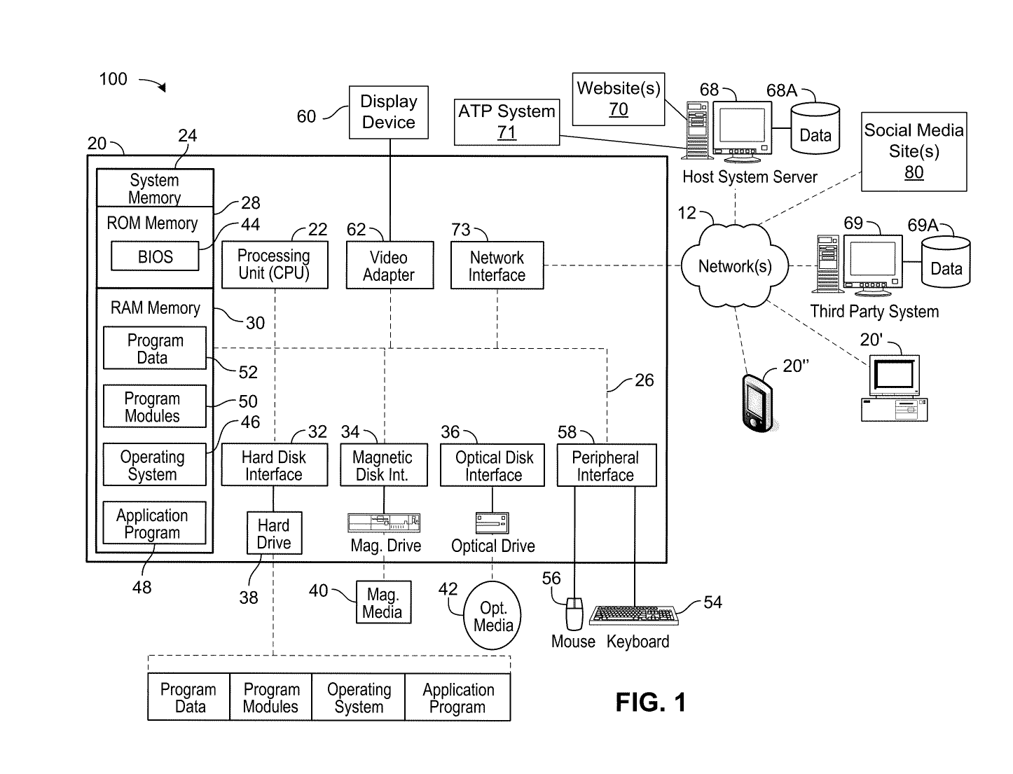

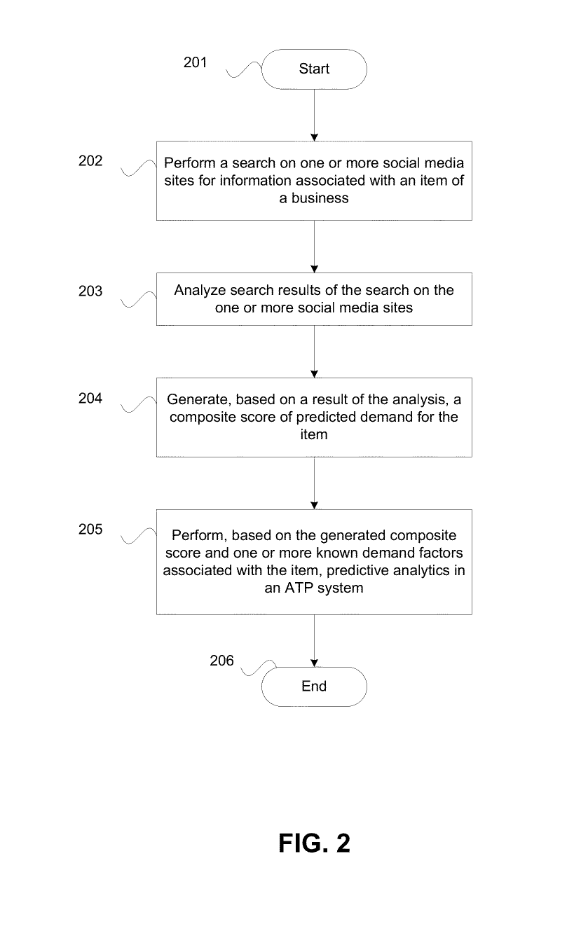

Certain embodiments of the disclosure may be found in a method and system for using social media for predictive analytics in available-to-promise (ATP) systems. Aspects of the method are provided, substantially as shown in and described with respect to at least one of FIGS. 1-2, for using social media for predictive analytics in available-to-promise (ATP) systems. Another embodiment of the disclosure may provide a non-transitory computer readable medium or machine-readable storage, having stored thereon, a computer program having at least one code section executable by a machine, thereby causing the machine to perform the steps as described with respect to at least one of FIGS. 1-2, for using social media for predictive analytics in available-to-promise (ATP) systems. Aspects of the system are provided, substantially as shown in and described with respect to at least one of FIGS. 1-2, for using social media for predictive analytics in available-to-promise (ATP) systems.

In various embodiments of the disclosure, a computing device, which comprises an available-to-promise (ATP) system of a business, may be operable to perform a search on one or more social media sites for information associated with an item of the business. The computing device may be operable to analyze search results of the search on the one or more social media sites. Based on a result of the analysis, a composite score of predicted demand for the item may be generated by the computing device. The computing device may then be operable to perform, based on the generated composite score and one or more known demand factors associated with the item, predictive analytics in the ATP system for generating a demand forecast for the item.

FIG. 1 is a block diagram illustrating an example computer network environment 100 for using social media for predictive analytics in an available-to-promise (ATP) system, in accordance with an example embodiment of the disclosure. Referring to FIG. 1, there is shown a computer network environment 100. In the computer network environment 100, a processing device 20″, illustrated in an example form of a mobile communication device, a processing device 20′ illustrated in an example form of a computer system, and a processing device 20 illustrated in an example schematic form are shown.

Each of these processing devices 20, 20′, 20″ are provided with executable instructions to, for example, provide a means for a user to access (among other things) a host system server 68 which may support one or more host organization websites 70. In this regard, the host system server 68 may be associated with a merchant or business and a hosted organization website 70 may be a public website (e.g., an online retail environment or online retail store) of the merchant or business. In addition, such a host system server may support a social network that enables interaction of members of a loyalty program of the merchant or business. In some instances, a user may be an employee of the merchant or business such as, for example, a network administrator, a sales associate, a customer service agent, or other individual who provides product and/or sales related assistance to customers of the merchant or business. In this regard, the executable instructions may also provide a means for the user (i.e., in this example, the employee) to be connected to, for example, a product database, an organization's intranet, a supplier database, a website development environment, etc. In some other instances, a user may be a customer or consumer of the merchant or business. In this regard, the executable instructions may also provide a means for the user (i.e., in this example, the customer) to be connected to, for example, a hosted social networking site, a user profile, a store directory, a sales associate, a customer service agent, etc.

Generally, the computer executable instructions reside in program modules which may include routines, programs, objects, components, data structures, etc. that perform particular tasks or implement particular abstract data types. Accordingly, the processing devices 20, 20′, 20″ illustrated in FIG. 1 may be embodied in any device having the ability to execute instructions such as, by way of example, a personal computer, mainframe computer, personal-digital assistant (“FDA”), mobile phone, tablet, e-reader, smart phone, or the like. Furthermore, while described and illustrated in the context of a single processing device 20, 20′, 20″, the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit (processor) 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, the hard drive 38, and/or the peripheral memory devices may be used to store computer executable instructions comprising an operating system 46, one or more applications programs 48 (such as, for example, a Web browser), other program modules 50, and/or program data 52. Still further, computer-executable instructions may be downloaded to one or more of the processing devices 20, 20′, 20″ as needed, for example via a network connection.

To allow a user to enter commands and information into the processing device 20, input devices such as a keyboard 54 and/or a pointing device (e.g., a mouse) 56 are provided. While not illustrated, other input devices may include, by way of example and not limitation, a microphone, a joystick, a game pad, a scanner, a camera, a touchpad, a touch screen, etc. These and other input devices are typically connected to the processing unit (processor) 22 by means of a peripheral interface 58 which, in turn, is coupled to the bus 26. Input devices may be connected to the processor 22 using interfaces such as, for example, a parallel port, a game port, a FireWire® interface, or a universal serial bus (USB) interface. To view information from the processing device 20, a display device 60 may also be connected to the bus 26 via an interface, such as a video adapter 62. The display device 60 may be, for example, a coupled monitor, an integrated display module, or other suitable type of display device. The display device 60 may comprise, for example, a presence-sensitive screen such as a touchscreen or touch-sensitive screen. In addition to the display device 60, the processing device 20 may also include other peripheral output devices (not shown), such as, for example, speakers, cameras, printers, or other suitable devices.

As noted, the processing device 20 may also utilize logical connections to one or more remote processing devices, such as the host system server 68 having associated data repository 68A. In this regard, while the host system server 68 has been illustrated in the exemplary form of a computer, the host system server 68 may, like processing device 20, be any type of device having processing capabilities. Again, the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems (e.g., a third party system 69) via a network 12, such as, for example, the Internet, local area network (LAN), metropolitan area network (MAN), wide area network (WAN), cellular network, cloud network, enterprise network, virtual private network, wired and/or wireless network, or other suitable network, and via such connections, will be associated with data repositories (e.g., a data repository 69A) that are associated with such other third party systems. Such third party systems may include, without limitation, systems of banking, credit, or other financial institutions, systems of third party providers of goods and/or services, systems of shipping/delivery companies, systems of product manufacturers, systems of media content providers, document storage systems, etc.

For performing tasks as needed, the host system server 68 may include many or all of the elements described above relative to the processing device 20. For example, the host system server 68 may be operable to implement an online retail channel of the merchant or business. In this regard, one or more online stores of the merchant or business may allow customers to shop for items and/or services sold by the merchant or business using one or more websites 70 of the merchant or business. In addition, the host system server 68 would generally include executable instructions for, among other things, performing various tasks in accordance with various example embodiments of the present disclosure.

In an example embodiment of the disclosure, the host system server 68 may comprise an inventory availability system such as, for example, an available-to-promise (ATP) system 71. The ATP system 71 may provide a response to customer order enquiry, based on resource availability. For example, a customer order enquiry may be submitted on the website 68 from the processing device 20, via the network(s) 12. The ATP system 71 may support order promising and fulfillment, aiming to manage demand and match it to production plans of the business.

In an example embodiment of the disclosure, the host system server 68 may be operable to communicate with one or more social media sites (also known as “social media websites” or “social networking websites”) 80, for example, via the network(s) 12. Various social media may comprise, by way of example and not limitation, collaborative projects, blogs/microblogs, content communities, social networking, virtual game worlds, and virtual social worlds, etc.

Communications between the processing device 20 and the host system server 68 may be performed via a further processing device, such as a network router (not shown), that is responsible for network routing. Communications with the network router may be via a network interface component 73. Thus, within such a networked environment, e.g., the Internet, World Wide Web, LAN, cloud, or other like type of wired or wireless network, program modules depicted relative to the processing device 20, or portions thereof, may be stored in the non-transitory computer-readable memory storage device(s) of the host system server 68.

In operation, a computing device such as the host system server 68, which comprises the ATP system 71 of the merchant or business may, in one example embodiment of the disclosure, be operable to perform a search on one or more social media sites 80 for information associated with an item currently or anticipated to be offered by the merchant or business. For example, a social media site 80 may be a website of, by way of example and not limitation, blog, chatter, discount deals, product coupons, product reviews, interactive feeds, comments, videos, etc. The information associated with the item may comprise, for example, reviews on the item, chatting about the item, sharing of the item, etc. The item of the merchant or business may comprise, by way of example and not limitation, a product, a part of a product, or a service provided by the merchant or business. The computing device (e.g., the host system server 68) may be operable to analyze search results of the search on the one or more social media sites 80. Based on a result of the analysis, a composite score of predicted demand for the item may be generated by the computing device. In this regard, the composite score may correspond to external demand factor associated with the item. The computing device may then be operable to perform, based on the generated composite score and one or more known demand factors associated with the item, predictive analytics in the ATP system 71 for generating a demand forecast for the item. In this regard, the one or more known demand factors (i.e., known to the merchant or business internally) may comprise, for example, historical demand data, manufacturing capacity, and/or other similar quantitative or stochastic demand information.

FIG. 2 is a flow chart illustrating example steps of a method for using social media for predictive analytics in an available-to-promise (ATP) system, in accordance with an example embodiment of the disclosure. The illustration of FIG. 2 makes reference to the example computer network environment 100 of FIG. 1. Referring now to the method of FIG. 2, the example steps start at step 201. In step 202, the computing device (e.g., the host system server 68) comprising the ATP system 71 of the merchant or business, may be operable to perform a search on one or more social media sites 80 for information associated with an item of the merchant or business. In step 203, the computing device may be operable to analyze search results of the search on the one or more social media sites 80. In step 204, based on a result of the analysis, a composite score of predicted demand for the item may be generated by the computing device. In step 205, the computing device may then be operable to perform, based on the generated composite score and one or more known demand factors associated with the item, predictive analytics in the ATP system 71 for generating a demand forecast for the item. The example steps may proceed to the end step 206.

In another example embodiment of the disclosure, a computer system (e.g., host system server 68) may collect various forms of information content from one or more information sources that may include, by way of example and not limitation, various merchant web sites and web sites for exchanging or providing information about product promotions and deals, blogs, and communication networks such as, by way of example and not limitation, those supported by social networking web sites such as Facebook©, Twitter©, Pinterest©, Instagram©, and tumblr©, to name only a few examples. A suitable computer system may, for example, include one computer with multiple processors, or multiple computers each with one or more processors, and the computers may be located together, or may be geographically distributed and communicatively coupled.

Such social networking web sites may, for example, be operated by a merchant or business as part of functionality provided via a social e-commerce web site. The various forms of information content may include, by way of example and not limitation, information related to various product items or services of a merchant or business. The information content may include, for example, comments and reviews, discussions, posts, video content related to various products or services, information about offers or deals on products or services, and information representative of the use by consumers of various social indicators of consumer sentiment such as “like,” “want,” “have,” “own,” “thumbs-up,” “+1,” and the like with respect to various product items or services. The collected information content may include information about offers, deals, and promotions of products or services. Such information content may include product or service prices, and currently available quantity of products for sale by various merchants or businesses.

The computer system may also collect information of a particular merchant or business, including that of the merchant or business employing the ATP system 71, regarding various products or services including, by way of example and not limitation, current and historical product inventory or service availability information, current and historical product or service demand information, product or service sales and refund information, promotion and pricing information, and current outstanding product orders placed by the merchant or business. In addition, the system may collect product manufacturer information such as, by way of example and not limitation, product manufacturer production capacity information, and information representing manufacturer production time from order to delivery (e.g., product order lead time). The collection of such information content may, for example, be performed using software programs or “bots” that systematically examine various web sites and capture the information content that is found with or without cooperation of the web site sponsors or operators, or may be received directly from computer systems of the sources of the information.

In some embodiments of the disclosure, the computer system may perform analysis on various portions of the collected information content, including the information content collected from one or more social networks, and may classify the various portions of such information content. Classification of the various portions of collected information content may be performed using, by way of example and not limitation, natural language processing, and the classification may be used to, for example, identify the subject matter and any present indication of consumer sentiment of each analyzed portion of the information content. In particular, the analysis may identify a particular product or product category to which the information content relates, and the nature of the information content such as, by way of example and not limitation, that a particular portion of the collected information content represents consumer sentiment such as, for example, a positive (or negative) review of or reaction to an identified product, discusses a deal or offer for an identified product, expressions indicating excitement, urgency, or purchase intent, or is some other form of communication or information related to an identified product.

Such information may, for example, be extracted and included in a repository of data items, including the product-related information of a merchant or business, and data items derived from the classification and analysis of the collected information content described above. Such a repository may be referred to herein as a “data set,” and may also include various other data items related to products such as, by way of example and not limitation, product details such as information identifying a manufacturer or brand, a model, a style, a color, a finish, a size, a designer; product features; product pricing; product value; product availability; product reliability; current or future offers related to the product, including coupons, discounts, and/or rebates; and suitability of the product for a particular use or within a particular geographic region.

In some embodiments of the disclosure, the computer system may include functionality that uses the collected and classified information content to generate, by way of example and not limitation, an aggregate or composite score, and/or one or more weighting factors that are representative of predicted demand for a particular product or service. A computer system of the present disclosure may execute software code that analyzes a data set of a data repository such as the example repository described above, to identify a particular set or combination of data items that are positively correlated with the sale of a particular product item or service. An embodiment of the present disclosure may, for example, use one, or a combination of more than one of a number of different analysis techniques to identify the set or combination of data items. Such analysis techniques include, by way of example and not limitation, linear regression analysis, means clustering, Bayesian decision models, and/or Markov decision chains, or any other suitable analysis technique. An embodiment in accordance with the present disclosure may use a machine learning (ML)-based approach that employs any or all of such analysis techniques to arrive at an aggregate or composite score representative of future demand, which may then be mapped to numbers that may, for example, represent a range of a quantity of a particular product to purchase or manufacture and/or a range of a quantity of a particular product to allocate to various merchant locations and/or product distribution channels for sale to consumers. As mentioned above, the aggregate or composite score may be a weighted sum of a variety of different analysis techniques such as the example analysis techniques identified above, and the set of weights assigned to the contribution to the aggregate or composite score of each of the analysis techniques used may be based on a number of factors including, by way of example and not limitation, the particular product or service of interest. In an embodiment of the disclosure, the aggregate or composite score, the set of weights assigned to each of the analysis techniques used, the set of data items found to be positively correlated to sales, and/or the range of a quantity of a particular product to manufacture and/or the range of a quantity of a particular product or service to allocate to various merchant locations and/or product distribution channels may then be provided to a suitable ATP system platform.

In addition to the above, the computer system of an embodiment of the present disclosure may include functionality that tracks consumer demand for a particular product or service by, for example, tracking sales and/or orders for the particular product or service, and that also tracks availability of a particular product or service by, for example, tracking incoming shipments or current inventory of the particular product or resources available to provide the service. In an embodiment of the disclosure, such tracking of demand for a particular product or service, and/or the tracking of the availability of a particular product or service, may be performed in real-time. The results of such tracking of demand and availability of a particular product or service, or for a variety of products or services, may then be fed back into the ML-based approach discussed above, so that over time, the analysis technique(s) that result in a better allocation forecast for a given product or service may be more heavily weighted in the calculation of the aggregate or composite score described above. Thus, in the manner described above, an embodiment of the disclosure may use indicators of consumer sentiment about various products or services found in information content of various information sources, including social media communicated via social networks, as a factor in the generation of information representative of predicted consumer demand for those products or services. Such predictions enable an available to promise system of a merchant or business to guide decisions impacting product and service resource availability activities to more accurately meet consumer demand, and thereby improve revenue of the merchant or business offering the products or services.

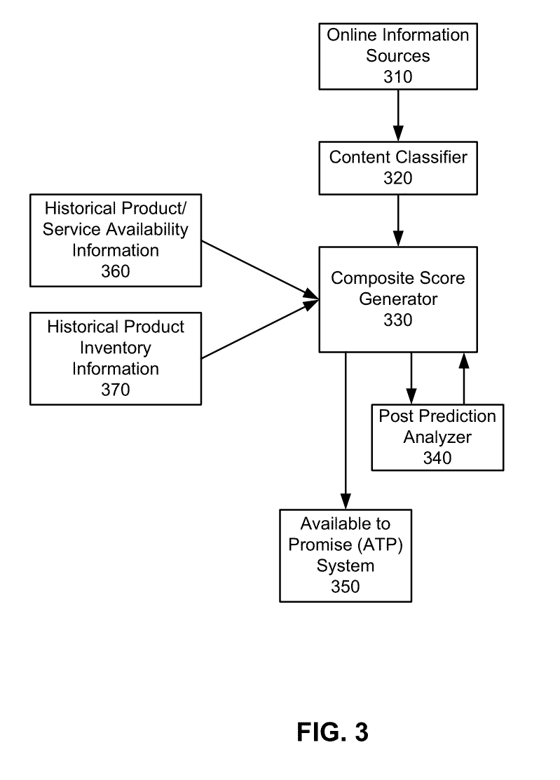

FIG. 3 is a data flow diagram illustrating the flow of information to and from the various functional elements of a system for using social media for predictive analytics in an available-to-promise (ATP) system, in accordance with the present disclosure. As illustrated in FIG. 3 and discussed above, an embodiment of the disclosure may collect information content from various online information sources 310, that may include, by way of example and not limitation, various web sites, including social networking web sites. Such information content may comprise various types of communications by users of those web sites, as discussed above, and such types of communication may relate to various products or services, and may contain information representing consumer sentiment about the various products and services in those communications. Such collected information content may be stored in a data repository for later processing, such as in the data repository 68A of FIG. 1, or may be processed as the information content is collected. In an embodiment of the disclosure, a content classifier 320 may then classify various portions of the collected information content and may store various data items extracted from the collected information content, such as those discussed above. The content classifier 320 may comprise software running on a computer system such as, for example, the host system server 68 of FIG. 1, and the data items extracted from the collected information content may be stored in a data repository such as the example data repository 68A of FIG. 1. In some embodiments of the disclosure, the content classifier 320 may perform natural language processing upon the collected information content to extract the various data items.

An embodiment of the present disclosure may also comprise functionality that generates score information, such as the example composite score generator 330 functionality shown in FIG. 3. Such functionality may analyze the various data items extracted from the collected information content, and may also employ historical data regarding product or service availability and product inventory from the merchant or business operating or sponsoring the system of FIG. 3, such as the historical product/service availability information 360 and historical product inventory information 370 of FIG. 3, to generate an aggregate or composite score and one or more demand factors or weighting factors. In some embodiments of the disclosure, functionality such the composite score generator 330 may implement heuristics using a machine learning-based approach, which may use one or more analysis techniques to identify a set of data items that exhibit a positive correlation with the sale of each of the products or services identified from the collected information content, as discussed above. The composite score and demand factor information generated by the composite score generator 330 may then be mapped to ranges of numerical values representing the predictions of the amounts or quantities of each product or service resource needed and allocations for various locations or channels of the merchant or business, which are then provided to an available-to-promise system, such as the ATP system 350 of FIG. 3.

An embodiment of the present disclosure may also include functionality that tracks product/service availability and product inventory of the merchant or business, such as the post prediction analyzer 340 of FIG. 3. Such functionality may be performed by a computer system such as the host system server 68 of FIG. 1. Such tracking may be performed in real-time using transaction data from processing devices such as, by way of example and not limitation, point-of-sales terminals and e-commerce web site platforms of the merchant or business. Information representing the actual tracked product/service availability and product inventory of the merchant or business may then be fed back into the composite score generator 330, for use in adjusting the analysis and heuristics used going forward.

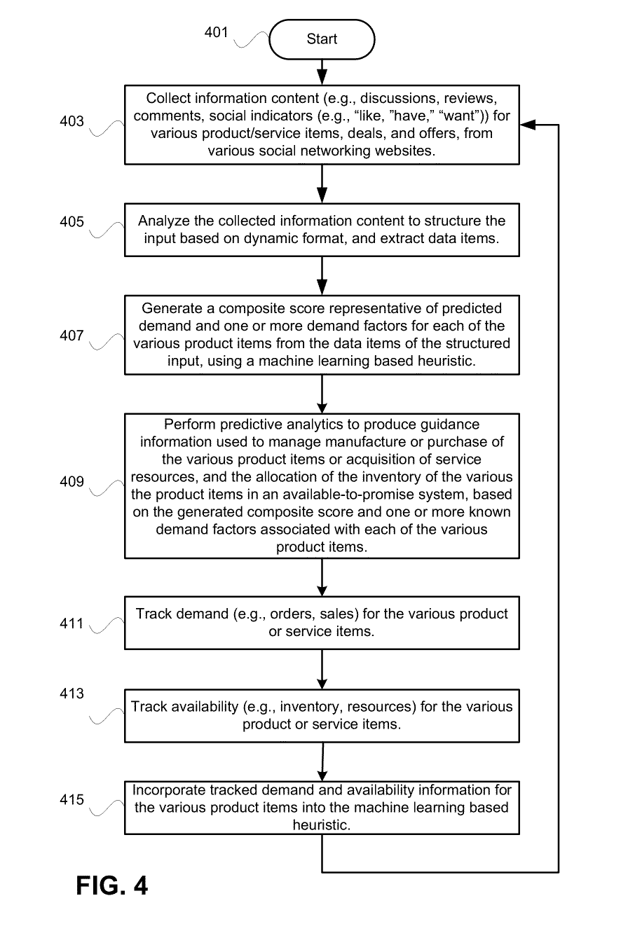

FIG. 4 illustrates an example method of operating a system for using social media for predictive analytics in an available-to-promise (ATP) system, in accordance with the present disclosure. The method of FIG. 4 may, for example, be performed by various elements of the computer network environment 100 of FIG. 1. It should be noted that the order of the actions illustrated in the steps of FIG. 4 may be modified without departing from the scope of the present disclosure, and that, although illustrated as a sequence of actions, some of the indicated actions may be implemented as independent and ongoing activities that produce information for use by other steps of the method of FIG. 4.

The method illustrated in FIG. 4 begins at the start block 401, which may occur when, for example, execution of software code used to perform the method of FIG. 4 is initiated on a computer system such as the host system server 68 of FIG. 1. The method of FIG. 4 then, at block 403, may direct the computer system to collect information content (e.g., discussions, reviews, comments, social indicators (e.g., “like,” “have,” “want”)) for various product/service items, deals, and offers, from various online sources, including social networking websites. Next, at block 405, the computer system performing the method may analyze the collected information content to structure the input based on the dynamic format of the information, and extract data items for later processing. Then, at block 407, the method may generate a composite score of predicted demand and one or more demand factors, for each of the various product items from the data items of the structured input, using a machine learning-based heuristic.

The method may then, at block 409, direct the computer system to perform predictive analytics to produce guidance information used to manage manufacture or purchase of the various product items or acquisition of service resources, and the allocation of the inventory of the various the product items in an available-to-promise system, based on the generated composite score and one or more known demand factors associated with each of the various product items. At block 411, the method of FIG. 4 illustrates that the method includes tracking of demand (e.g., orders, sales) for the various product or service items of the merchant or business. Although shown as part of the sequence of actions of the method of FIG. 4, this step may be performed as an ongoing activity of the computer system, and such tracked demand information may be available on a real-time basis. In addition, at block 413, the method of FIG. 4 illustrates that the method includes tracking of availability (e.g., inventory) for the various product or service items of the merchant or business. Although this action is also shown as part of the sequence of actions of the method of FIG. 4, this step may also be performed as an ongoing activity, and such tracked inventory information may be available on a real-time basis. Finally, the method, at block 415, may direct the computer system to incorporate the tracked demand and availability information for the various product or service items into the machine learning based heuristic used at block 409.

Aspects of the present disclosure may be seen in a method for using social media for predictive analytics in available-to-promise (ATP) systems of a merchant or business. Such a method may comprise collecting information content from a plurality of online sources, where the plurality of online sources comprises at least one web site of a social network, and analyzing the collected information content to identify and extract data items associated with a product or a service offered by the merchant or business. The method may also comprise generating a score representative of predicted demand for the product or service, using the extracted data items, and producing information representative of actual consumer demand for the product or service and availability of the product or service by tracking orders and inventory of the merchant or business. The method may further comprise incorporating the information representative of consumer demand for the product or service and availability of the product or service, into a heuristic used in generation of the score, and mapping the score to product quantity values used by the merchant or business to purchase and allocate the product or service for sale to consumers.

In an embodiment of the disclosure, the information content may comprise a consumer review or comment identifying the product or service, and the information content may comprise a promotional offer identifying the product or service. The extracted data items may comprise a representation of consumer sentiment identifying the product or service, and the generation of the score may be performed using a machine learning based system. The product quantity values used by the merchant or business to purchase and allocate the product or service for sale to consumers may comprise predicted ranges of quantities of the product or service to be purchased and allocated by the merchant or business for sale to consumers, and the social network may comprise an online community of individuals who use the website or other technologies to share information and/or resources with one another.

Additional aspects of the disclosure may be seen in a non-transitory computer-readable medium having a plurality of code sections, where each code section comprises a plurality of instructions executable by at least one processor. The instructions may cause the at least one processor to perform a method for using social media for predictive analytics in available-to-promise (ATP) systems of a merchant or business, such as the method described above.

Further aspects of the disclosure may be observed in a system for using social media for predictive analytics in available-to-promise (ATP) systems of a merchant or business. Such a system may comprise at least one processor for communicatively coupling to at least one user terminal device, where the at least one processor is operable to perform the actions of the method described above.

Accordingly, the present disclosure may be realized in hardware, software, or a combination of hardware and software. The present disclosure may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for using social media for predictive analytics in available-to-promise (ATP) systems of a merchant or business, the method comprising:
collecting information content from a plurality of online sources, the plurality of online sources comprising at least one web site of a social network;
analyzing the collected information content to identify and extract data items associated with a product or a service offered by the merchant or business;
generating a score representative of predicted demand for the product or service, using the extracted data items;
producing information representative of actual consumer demand for the product or service and availability of the product or service by tracking orders and inventory of the merchant or business;
incorporating the information representative of consumer demand for the product or service and availability of the product or service, into a heuristic used in generation of the score; and
mapping the score to product quantity values used by the merchant or business to purchase and allocate the product or service for sale to consumers.

2. The method according to claim 1, wherein the information content comprises a consumer review or comment identifying the product or service.

3. The method according to claim 1, wherein the information content comprises a promotional offer identifying the product or service.

4. The method according to claim 1, wherein the extracted data items comprise a representation of consumer sentiment identifying the product or service.

5. The method according to claim 1, wherein the generation of the score is performed using a machine learning based system.

6. The method according to claim 1, wherein the product quantity values used by the merchant or business to purchase and allocate the product or service for sale to consumers are predicted ranges of quantities of the product or service to be purchased and allocated by the merchant or business for sale to consumers.

7. The method according to claim 1, wherein the social network comprises an online community of individuals who use the website or other technologies to share information and/or resources with one another.

8. A non-transitory computer-readable medium having a plurality of code sections, each code section comprising a plurality of instructions executable by at least one processor to cause the at least one processor to perform a method for using social media for predictive analytics in available-to-promise (ATP) systems of a merchant or business, the steps of the method comprising:
collecting information content from a plurality of online sources, the plurality of online sources comprising at least one web site of a social network;
analyzing the collected information content to identify and extract data items associated with a product or a service offered by the merchant or business;
generating a score representative of predicted demand for the product or service, using the extracted data items;
producing information representative of actual consumer demand for the product or service and availability of the product or service by tracking orders and inventory of the merchant or business;
incorporating the information representative of consumer demand for the product or service and availability of the product or service, into a heuristic used in generation of the score; and
mapping the score to product quantity values used by the merchant or business to purchase and allocate the product or service for sale to consumers.

9. The non-transitory computer-readable medium according to claim 8, wherein the information content comprises a consumer review or comment identifying the product or service.

10. The non-transitory computer-readable medium according to claim 8, wherein the information content comprises a promotional offer identifying the product or service.

11. The non-transitory computer-readable medium according to claim 8, wherein the extracted data items comprise a representation of consumer sentiment identifying the product or service.

12. The non-transitory computer-readable medium according to claim 8, wherein the generation of the score is performed using a machine learning based system.

13. The non-transitory computer-readable medium according to claim 8, wherein the product quantity values used by the merchant or business to purchase and allocate the product or service for sale to consumers are predicted ranges of quantities of the product or service to be purchased and allocated by the merchant or business for sale to consumers.

14. The non-transitory computer-readable medium according to claim 8, wherein the social network comprises an online community of individuals who use the website or other technologies to share information and/or resources with one another.

15. A system for using social media for predictive analytics in available-to-promise (ATP) systems of a merchant or business, the system comprising:
at least one processor for communicatively coupling to at least one user terminal device, the at least one processor operable to, at least:
collect information content from a plurality of online sources, the plurality of online sources comprising at least one web site of a social network;
analyze the collected information content to identify and extract data items associated with a product or a service offered by the merchant or business;
generate a score representative of predicted demand for the product or service, using the extracted data items;
produce information representative of actual consumer demand for the product or service and availability of the product or service by tracking orders and inventory of the merchant or business;
incorporate the information representative of consumer demand for the product or service and availability of the product or service, into a heuristic used in generation of the score; and
map the score to product quantity values used by the merchant or business to purchase and allocate the product or service for sale to consumers.

16. The system according to claim 15, wherein the information content comprises a consumer review or comment identifying the product or service.

17. The system according to claim 15, wherein the information content comprises a promotional offer identifying the product or service.

18. The system according to claim 15, wherein the extracted data items comprise a representation of consumer sentiment identifying the product or service.

19. The system according to claim 15, wherein the generation of the score is performed using a machine learning based system.

20. The system according to claim 15, wherein the product quantity values used by the merchant or business to purchase and allocate the product or service for sale to consumers are predicted ranges of quantities of the product or service to be purchased and allocated by the merchant or business for sale to consumers.

21. The system according to claim 15, wherein the social network comprises an online community of individuals who use the website or other technologies to share information and/or resources with one another.
